(19) United States
(12) Patent Application Publication
(10) Pub. No.: US 2002/0102947 A1
(43) Pub. Date: Aug. 1, 2002

(54) Cell phone -hand set combination unit

(75) Inventor: Ofer Hofman, Timrat (IL)

Correspondence Address: BROWDY AND NEIMARK, P.L.L.C., 624 NINTH STREET, NW, SUITE 300, WASHINGTON, DC, 20001-5303, US

(73) Assignee: SITAL TECHNOLOGY AND HARDWEAR DEVELOPMENT (1997) LTD., Timrat (IL)

(21) Appl. No.: 10/002,626

(22) Filed: Dec. 5, 2001

Related U.S. Application Data
(63) Continuation-in-part of application No. 09/766,668, filed on Jan. 23, 2001.

(30) Foreign Application Priority Data
Jan. 9, 2001 (IL) 140817

(51) Int. Cl. H04B 1/38

(52) U.S. Cl. 455/90; 455/575

(57) ABSTRACT

A cell phone-hand set combination unit making it possible to operate a cell phone in the manner of a hand set. The unit includes a hand set provided with a mouthpiece having a microphone therein, an earpiece having a miniature loudspeaker therein, and a yoke bridging the mouthpiece and the earpiece, said yoke having a socket therein adapted to cradle a cell phone. The unit also includes a cell phone provided with a microwave transceiver to which is coupled a microphone and an ear phone; and an interface network housed in the yoke and operative when the cell phone is cradled in the socket to couple the cell phone to the hand set so that the microphone and earphone of the cell phone are supplanted by the microphone and speaker of the hand set which then functions like a cordless hand set.

### RELATED APPLICATION

This application is a continuation-in-part of the co-pending application Ser. No. 09/766,668 filed Jan. 23, 2001, titled “Adapter to Convert Cell Phone to Desktop Telephone”.

### FIELD OF THE INVENTION

This invention relates generally to portable, battery-powered cell phones, and in particular to an adapter for converting a mobile cell phone into a desktop telephone having a hand set, and to a cell phone-hand set combination unit, which unit is convertible into a speaker phone.

### BACKGROUND OF THE INVENTION

A cellular or cell phone is a portable radio telephone that is self sufficient, the phone being powered by a rechargeable battery. Contained in the case of a cell phone is a microwave transceiver connected to an internal microphone and speaker. On the face of the case is a dialing key pad and an LCD display screen. At the lower end of a conventional cell phone is a jack having contacts which when engaged by a plug inserted in the jack, then connect the cell phone to a battery charger or to an external microphone and speaker which supplant those in the cell phone.

Cell phone systems employ equipment operating in an assigned band of the microwave range. A user of a cell phone can travel from cell to cell in an urban environment, the system keeping tack of these movements, whether or not the user is initiating or receiving a radio-telephone interconnect call.

A major advantage of a cell phone is its mobility, for it may be carried on the person of its user, making it possible to operate the phone in both indoor and outdoor environments as well as on moving vehicles. There are however certain drawbacks to the use of a cell phone, one being that it is difficult to operate when the ambient noise level is high. These noises are picked up by the cell phone transceiver and mask the user's voice. Extraneous noises heard by the user of the cell phone, interfere with the vocal sounds coming from the cell phone speaker.

A conventional desktop telephone is a wired stationary instrument, for it is tethered by a cable to a telephone line outlet which connects it to a telephone network, the line also supplying dc power to the telephone set. The console of a desktop telephone rests on a desk or tabletop and is provided with a dialing keypad next to which is a socket to accommodate a hand set housing a microphone and a speaker. The hand set is connected though a cord extending from a console jack.

In a conventional desktop telephone in which the hand set is received in a socket on the console, the socket has mounted therein a depressible control switch. When a user lifts the hand set in order to make a call, the resultant switching action is such as to produce a dialing tone permitting the user to dial the number of the party he wishes to call. When the user returns the hand set to its socket, the resultant switching action is such as to inactivate the phone so that it is only responsive to a ring signal indicative of an incoming call. Then when the user lifts the hand set away from its socket to receive the incoming call, the resultant switching action activates the telephone and connects the head set to the telephone line.

A major advantage of a standard desktop telephone, whether installed in a house, an office or in any other facility, lies in its convenience and comfort. A user of a desktop telephone is usually comfortably seated next to the desk on which the telephone rests and is therefore able while on the phone to take notes on a desk pad or to consult papers placed on the desktop. Also the user, instead of holding the hand set in one hand while on the phone, can wedge the phone between his shoulder and head, and then have both hands free as he converses with the caller.

A drawback of a wired conventional desktop telephone is that its hand set is tied to it by a cord and therefore cannot be used away from the desk. To overcome this drawback, it is known to provide a “cordless” hand set which incorporates a microwave transceiver communicating with a base unit connected by the cable to a telephone-line wall outlet. One such arrangement is disclosed in the U.S. patent to Helstab et al. No. 6,073,031.

Inasmuch as an adapter in accordance with the invention serves to convert a cell phone into a desktop telephone having a hand set whose microphone and speaker then supplant those in the cell phone, of prior art interest is the U.S. Pat. No. 5,588,041 to Meyers Jr. et al.

The Meyers et al. patent discloses a cell phone useable in a vehicle, the cell phone being associated with a hand set whose cord plugs into the jack of the cell phone, whereby the microphone and speaker of the hand set then supplant those in the cell phone. The hand set is suspended from a hang-up cup. This combination of a hand set and cell phone does not create a desktop telephone in which switching actions are effected when the hand set is lifted from a socket on a desk console, and when the head set is placed back in its socket.

A desktop telephone in accordance with the invention includes a cradle to nest a cell phone. Hence, of prior art interest in this regard in the 1998 British Patent GB 232 0990. The British patent discloses a cell phone received in a cradle attached to the trouser waist of the user. A headset is suspended from, the cradle, the head set which includes a microphone and an earphone being connected by an extendable cable to the cell phone in the cradle. This arrangement cannot function as a desktop telephone.

A hand set has an advantage over a cell phone for it is ergonomically superior thereto and can be comfortably handled during prolonged use. The earpiece of a hand set which is provided with a miniature loudspeaker can be placed directly against the ear to exclude extraneous sounds, whereas the earphone in a cell phone which is disposed at the upper end of is case does not fit against the ear to exclude extraneous sounds.

In a hand set, the microphone is within a mouthpiece shaped to be placed adjacent the mouth of the individual holding the set so that it is mainly the speaker's voice that is picked up by the microphone. In a cell phone the microphone is at the lower end of the case and picks up ambient sounds as well as the speaker's voice.

### SUMMARY OF THE INVENTION

The main object of this invention is to provide wireless communication units which combine a cell phone with a hand set and have the advantages thereof without their drawbacks.

More particularly, it is an object of this invention to provide an adapter for converting a cell phone into a desktop telephone, which adapter includes a console on which is mounted a cradle which receives a cell phone and connects it to a hand set accommodated in a socket adjacent the cradle, thereby integrating the cell phone with the desktop telephone.

Also an object of this invention is to provide a combination unit in which a cell phone is incorporated within a hand set whereby the unit functions as if it were a cordless hand set.

Yet an object of the invention is to provide an adapter for a video cell phone having a video camera and a video screen to convert this phone into a video desktop telephone.

Among the significant advantages of a desktop telephone in accordance with the invention are the following:

A. The telephone, though capable of carrying out all of the functions of a conventional desktop telephone, is wireless and therefore requires no connection to a telephone line out)et or to a power line outlet.

B. The telephone behaves like an ordinary desktop telephone, for when its hand set is lifted away from its socket, the resultant switching action activates the telephone, and when the hand set is returned to its socket, the resultant switching action renders the telephone inactive in readiness to receive an incoming call.

C. The telephone, though mainly intended to be placed on a desktop, can be placed at whatever site in a residence in an office or elsewhere suits the convenience of its user.

D. The telephone combines the advantages of a conventional cell phone with those of a standard desktop telephone without their drawbacks. The cell phone converted by the adapter into a desktop telephone can readily be attached to and detached therefrom. Thus when the user leaves his home, he can take along his cell phone, and when he returns, he can then put it back into the adapter. Hence the user need not go to the expense of having both a cell phone and a desktop phone, nor will he be required to pay different companies for the calls he makes.

E. Despite the fact that a desktop telephone in accordance with the invention includes a microwave transmitter, when its hand set is held next to the user's head, no microwave energy radiates from the hand set or from its cord. Consequently, the wireless telephone is safe to use.

F. All of the features incorporated in a standard cell phone in which data is displayed on an LCD or other screen such as call monitoring and call waiting are now available in a desktop setting.

G. When cradled in the adapter is a video cell phone which includes a video screen to display an image of a part being spoken to and a video camera to pick up an image of the speaker, the console configuration is such as to enhance these images.

H. An adapter in accordance with the invention for converting a cell phone into a desktop phone may be mass-produced at relatively low cost.

Briefly stated in a first embodiment of the invention, these objects are attained in an adapter to convert a mobile cell phone having a battery-powered transceiver and a key pad into a desktop telephone, the adapter including a console that rests on a desktop and is provided with a cradle to nest the cell phone. Next to the cradle is a socket to accommodate a hand set whose microphone and speaker are connected by a cord extending from the hand set to a plug inserted in a console jack.

The console jack is connected by an interface network to a plug mounted on the cradle. The cell phone is provided with a jack having contacts which are connectable to an external microphone and speaker to supplant these in the cell phone connected to its transceiver. Insertion of the cell phone in the cradle causes the cradle plug to engage the cell phone jack, thereby connecting the microphone and speaker of the hand set via the interface network to the transceiver of the cell phone whose key pad now functions as the dialing pad of the desktop phone.

The interface network is governed by a control switch which functions in two switching modes, the first of which takes effect when the hand set is in its socket, the second when it is lifted therefrom. In the first switching mode, the cell phone is rendered inactive except to receive a ring signal indicative of an incoming call. In the second switching mode, the cell phone is activated to convey the incoming call to the hand set.

In a second embodiment of the invention, a combination unit is provided in which the cell phone is incorporated within a hand set whereby the microphone of the cell phone is supplanted by the microphone of the hand set and the earphone of the cell phone is replaced by the miniature loudspeaker of the headset.

In a third embodiment, the combination cell phone hand set unit is plugged into a speaker phone unit whose microphone supplants the microphone of the hand set and whose loudspeaker supplants the miniature loudspeaker of the hand set.

### BRIEF DESCRIPTION OF THE DRAWINGS

For a better understanding of the invention as well as other objects and features thereof, reference is make to the annexed drawings wherein:

FIG. 1 is a perspective view of a fit embodiment of the invention which is an adapter to convert a cell phone into a desktop telephone provided with a hand set;

FIG. 2 is the same as FIG. 1 except that the hand set is shown removed from its socket;

FIG. 3 is a separate view of the cradle in the desktop telephone;

FIG. 4 shows a section of the socket which accommodates the hand set;

FIG. 5 is a block diagram of the desktop telephone;

FIG. 6 is a schematic circuit diagram of the desktop telephone;

FIG. 7 shows an adapter for converting a video cell phone into a video desktop telephone.

FIG. 8 illustrates a second embodiment of the invention in which a cell phone is integrated with a hand set to provide a combination unit;

FIG. 9 illustrates the socket in the hand set in which is nested the cell phone of the combination unit;

FIG. 10 is a section taken through the hand set socket; and

FIG. 11 illustrates a third embodiment of the invention in which a combination cell phone-hand set unit is combined with a speaker phone unit.

### DETAILED DESCRIPTION OF THE INVENTION

First Embodiment

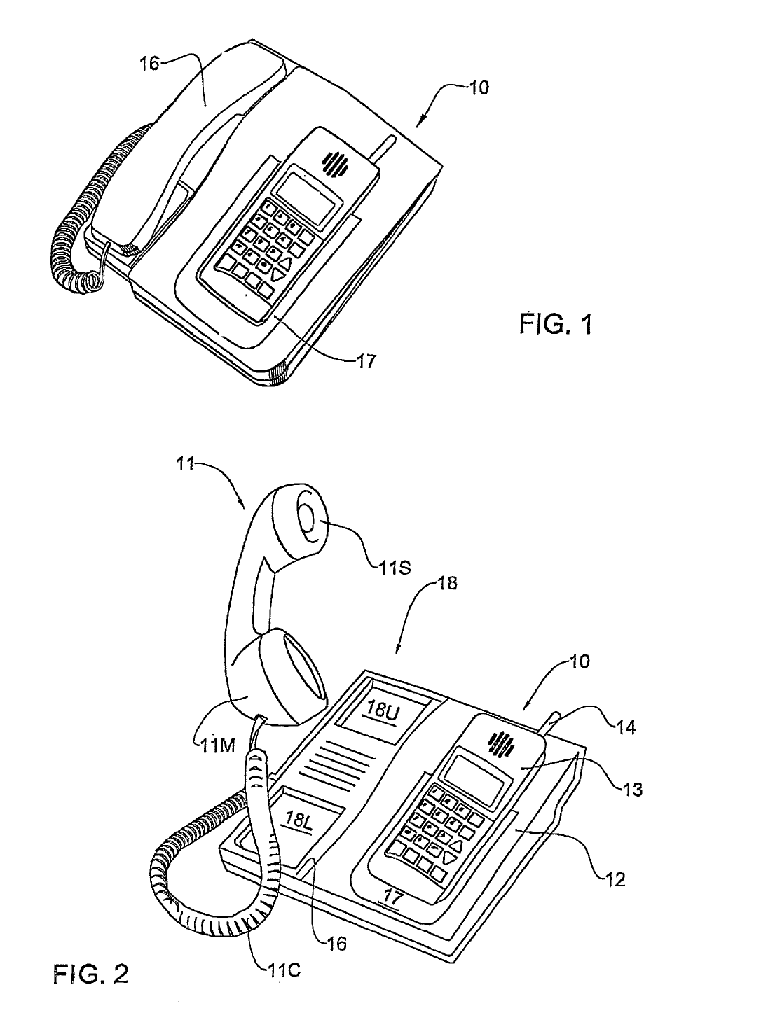

An adapter in accordance with the invention acts to convert a mobile cell phone, such as cell phone 10 shown in FIGS. 1 and 2, into a desktop telephone provided with a standard hand set 11 having at its upper end a speaker section 11S and at its lower end a microphone section 11M, a cord 11C extending from the hand set.

The advantage of a hand set over a cell phone which also has a microphone and speaker, is that a hand set is anatomically contoured so that the earpiece of its speaker section 11S covers the ear of the user, whose hearing is then confined to the sounds coming out of the earpiece and excludes extraneous noise. And the mouthpiece of the microphone section 11M is then adjacent the mouth of the user and picks up mainly the voice of the user.

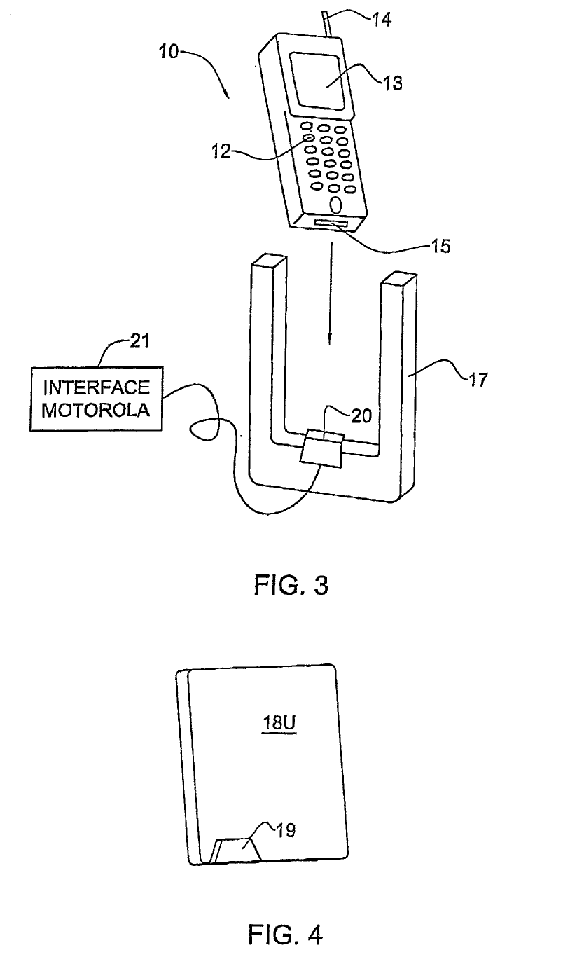

Cell phone 10, shown separately, in FIG. 3 includes a dialing keypad 12, an LCD display screen 13 and a short antenna 14. Antenna 14 emits microwave energy, but because it is situated in the adapter on a desktop, it is not close to the head of the user of the desktop telephone. Hence the user is not subjected to microwave radiation from the cell phone antenna. However, the cell phone is electrically coupled to the cord 11C of hand set 11 which then acts as an auxiliary antenna radiating microwave energy. To prevent microwave energy carried by the line connecting the cell phone to cord 11C, an R-F choke is interposed in this line, as will be later described.

Cell phone 10 includes a transceiver powered by a rechargeable battery. At the bottom end of cell phone 10 is a jack 15 having a set of contacts for connecting the rechargeable battery in the cell phone to an external charger. There are also contacts for connecting the transceiver of the cell phone to an external microphone and speaker. When an external microphone and speaker are connected to the cell phone, they then supplant the internal microphone and speaker normally coupled to the transceiver.

The adapter includes a generally rectangular console 16 having a flat, cushioned base so that it can be rested on a desk or tabletop or on any other flat surface. A desktop telephone in accordance with the invention is wireless in the sense that it is not wired by a cable to a telephone line outlet or to a power line outlet, and the unit can therefore be carried about and placed wherever it suits the user's convenience.

Mounted on the face of console 16 is a U-shaped cradle 17 which is dimensioned to receive and nest cell phone 10, the arms of the cradle embracing the sides of the cell phone, and being joined together by a yoke. In practice the arms way be provided with a resemble latching mechanism (not shown) to securely hold the cell phone in the cradle but which can easily be retracted to withdraw the cell phone from the cradle.

Next to cradle 17 nesting cell phone 10 is a socket 18 to accommodate hand set 11. Socket 18 has a lower section 18L to receive microphone section 11M of the hand set, and an upper section 18U to receive speaker section 11S. Mounted within upper section 18U is a depressible control switch 19 which has two switching modes, the first being the mode resulting from depression of the the switch by the speaker section 11S, the second being the mode resulting from the return of the switch to its initial position when the hand set is lifted to take speaker section 11S out of upper socket section.

Control switch 19 acts to govern the operation of an interface network 21 to which cell phone 10 is connected by way of a plug 20 mounted in the yoke of cradle 17 to engage the jack 15 of the cell phone when it is inserted in its cradle. Interface network 21 couples cell phone 10 in the cradle via an R-F choke 22 to a console jack 23 into which is plugged plug 24 of cord 11C extending from hand set 11.

R-F choke 22 acts to prevent cord 11C from behaving as an auxiliary microwave antenna radiating energy in the vicinity of the head of the user when holding the hand set against his ear. Choke 22 offers little resistance to the audio signal being fed on a line from the cell phone to the hand set, but it presents a high impedance and load to microwave energy being carried by the line.

Control switch 19 governs the operation of interface network 21 in the following manner:

A. When hand set 11 is placed in socket 18, switch 19 is then depressed to function in a first mode which renders cell phone 10 inactive so that it is then in condition only to receive a ring signal indicative of an incoming call.

B. When the user hears the ring signal and lifts the hand set to take the incoming call, switch 19 returns to its initial state to operate in a second mode activating the cell phone which now feeds the incoming audio signal via the interface network to hand set 11.

C. When the user wishes to make a call on the, desktop telephone, he then lifts the hand set from its socket to switch from the first to the second switching mode which renders the cell phone active so that the user can now dial the number of the party to whom he wishes to speak.

The Circuits of the Desktop Telephone

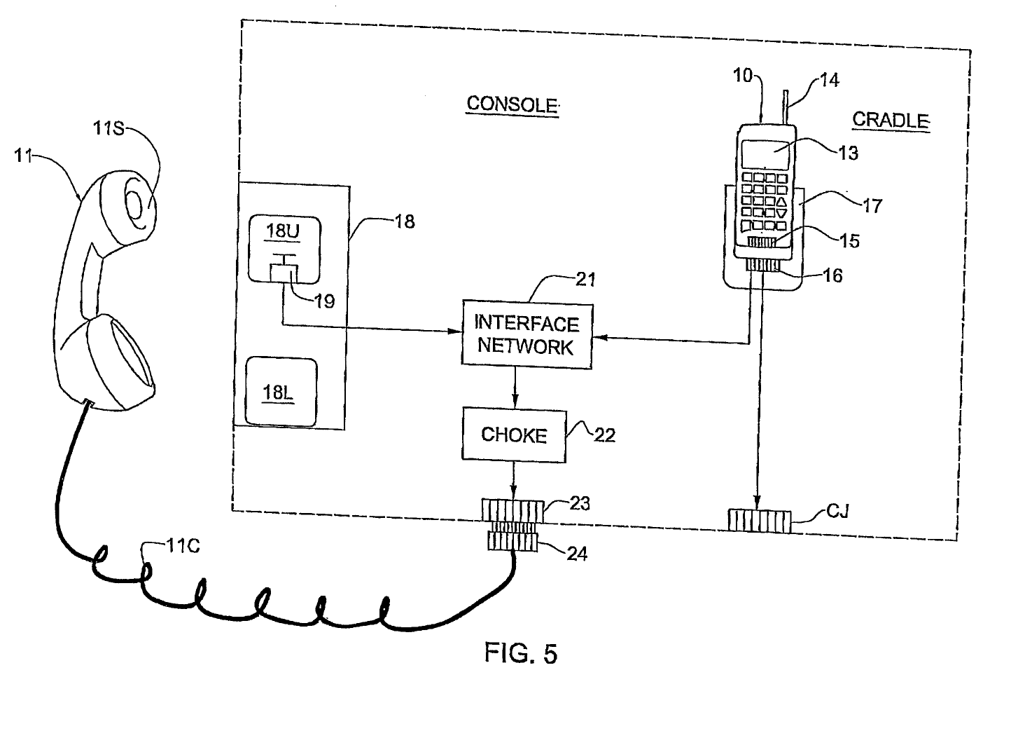

When the desktop telephone is in its operative state as shown in FIG. 5, cell phone 10 is then nested in cradle 17 and the cradle plug 20 is then inserted in cell phone jack 15, the cell phone now being connected to interface network 21 which is linked to hand set 11 via console jack 23 into which hand set cord 11C is plugged.

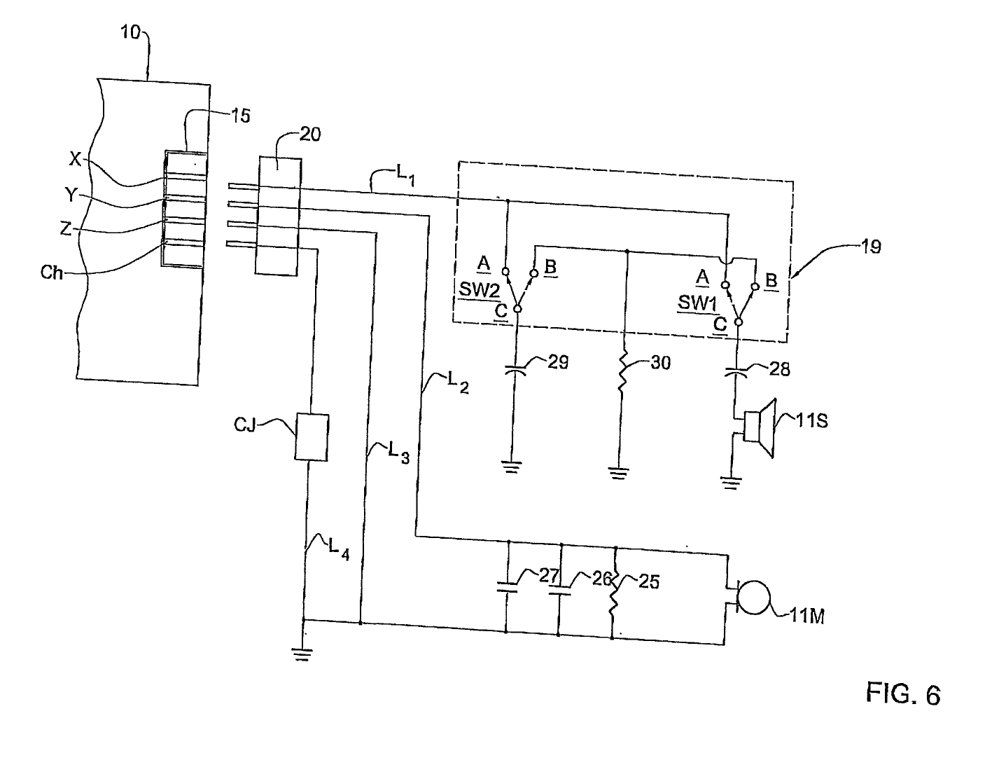

As shown in FIG. 6, control switch 19 which governs the operation of interface network 21 is composed of a pair of selector switch sections SW1 and SW2 each having fixed contact A and B and a movable contact C adapted to engage either one of the fixed contacts. Movable contacts C of switch sections SW1 and SW2 are ganged together in opposition so that when movable contact C of switch section SW1 engages its fixed contact B, then movable contact C of switch section SW2 engages its fixed contact A, and vice verse.

The fixed contacts A of switch sections SW1 and SW2 are both connected via a line L1 leading to cradle plug 20 which is plugged into cell phone jack 15 and engages the speaker X contact in the jack. Speaker contact X in cell jack 15 not only yields the audio signal from the cell phone transceiver but also its dc voltage (2.7 volts).

Contact Y in cell phone jack 15 is the microphone contact and therefore is connected by a line L2 to microphone section 11M in hand set 11 via a noise filter composed of a resister 25 in parallel with capacitors 26 and 27. This connection to line L2 is made by a prong in cradle plug 20 that engages the Y contact in cell jack 15. The noise filter acts to filter out the high-frequency noise components in the audio frequency spectrum of the signal picked up by the microphone. Hence what the user hears is substantially free of noise. The Z contact in cell jack 15 is connected by line L3 to ground, this being the common ground for the interface network and the noise filter. The CH contact in cell jack 15 is the battery charger contact which is connected by line L4 to a charger jack CJ mounted on the console. Hence to recharge the cell phone battery, it is not necessary to remove the cell phone from its cradle on the console, for all that need be done is to plug the charger into the charger jack CJ.

The connections between switch sections SW1 and SW2 of control switch 19 and the interface network composed of chargeable capacitors 28 and 29 and discharge resistor 30 and their functions will now be explained.

Movable contact C of SW1 is connected through capacitor 26 in series with speaker section 11S to ground. Movable contact C of SW2 is connected to ground through capacitor 29. Fixed contacts B of both SW1 and SW2 are connected to ground through resistor 30. Capacitors 28 and 29 and resistor 30 form the interface network 21 intercoupling the cell phone 11 with hand set 10 under the control of the hand set socket switch 19.

When hand set 11 is in place in the socket and control switch 19 is then depressed to assume its first operating mode, switch section SW2 then engages its contact A while switch section SW1 then engages its contact B as shown in FIG. 6. Because contact A of SW2 is connected by line L1 to contact X of the cell jack 15, /capacitor 29 then connected to contact A of SW2 is charged by the dc voltage carried by line L1.

And since contact B of SW1 is now connected to capacitor 28, then capacitor which had previously been charged, now discharges in the first mode through speaker 11S, one end of which is grounded and through resistor 30, one end of which is grounded. In this fist operating mode in which the hand set is placed in its socket, its speaker 11S is then disconnected from the cell phone which is inactive except to receive a ring signal indicative of an incoming call.

When in response to this ring signal the user lifts hand set 11 from its socket, switch 19 returns to its initial state (second mode of operation) in which SW1 engages its contact A and SW2 engages its contact B. When SW1 engages contact A it then connects capacitor 28 to line L1 to charge the capacitor with the dc voltage carried by his line. And at the same time it feeds the audio signal on line L1 to speaker 11S through contact B of SW1. But since capacitor 29 is now connected by contact B of SW1 to ground through resistor 30, the capacitor is then discharged.

When capacitor 28 is being charged, direct current is then sourced from cell phone 10, the resultant current surge being sensed to instruct the cell phone to connect the incoming call. When the call is completed and hand set 11 is returned to its socket to depress switch 19, switch sections SW1 and SW2 return to their initial state. As a consequence, the previously discharged capacitor 29 is again charged to produce a current surge that is sensed by the cell phone to instruct it to disconnect the cell, while previously charged capacitor 28 is now discharged.

Thus interface network in conjunction with switching sections SW1 and SW2 which are first actuated by lifting the hand set from its socket and then by putting it back in place, create a monostable direct current one-shot device responsive to the handling of the hand set.

Adapter for Video Cell Phone

A recent innovation in the technology of cell phones is the video cell phone. This phone is provided with a miniature video camera to obtain an image of the head of the user of the cell phone who is speaking into its microphone, a small scale video screen to display an image of the party to whom the user is speaking and a microwave television transceiver to transmit the voice and image of the speaker and to receive the voice and image of the party to whom the user is speaking.

One practical drawback of a video cell phone which is hand carried is that it is difficult when holding the cell phone to properly train the video camera onto the head of the holder while at the same time putting him in a position so as to clearly view the video screen.

But a more serious drawback of a video cell phone is that while it is a mobile instrument which can be used anywhere, one is ill advised to use it while walking or on a moving vehicle, for you cannot be looking at the video screen of a video cell phone while at the same time looking to see where you are going.

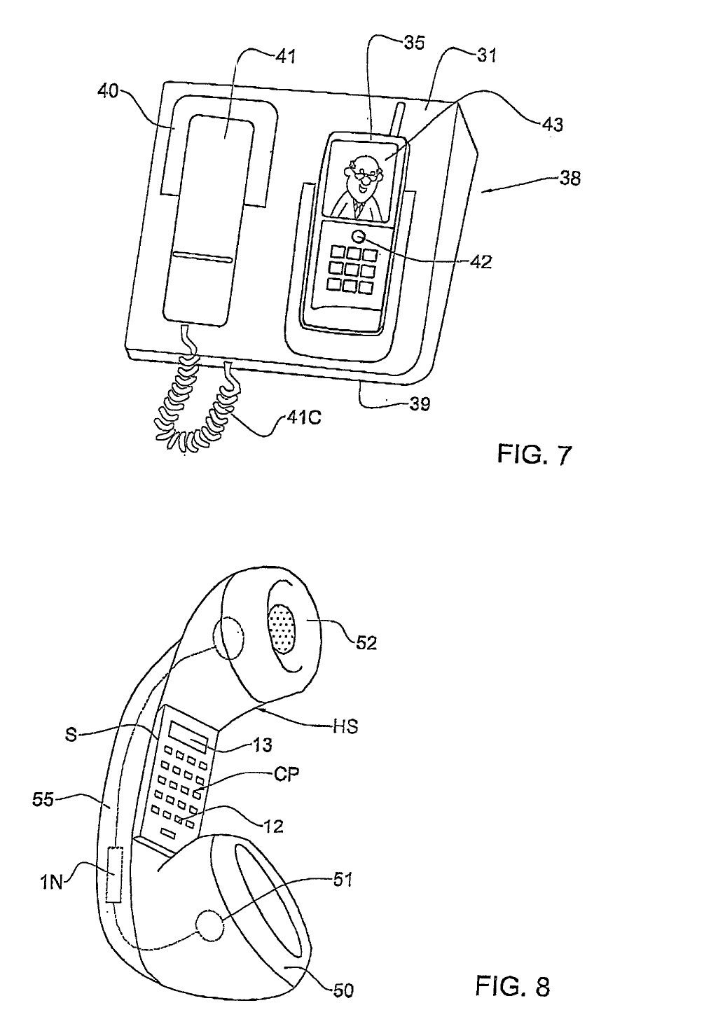

These drawbacks which impose restrictions on the use to which a video cell phone can be put are obviated in the adapter for a video cell phone illustrated in FIG. 7. This adapter is configured to convert a video cell phone into a video desktop telephone and to so orient the cell phone so that its video camera is properly trained on the head of the speaker, while he then sees a clear image on the screen of the video phone of the party to whom he is speaking.

As shown in FIG. 7, the video cell phone 35 is nested in a cradle 36 mounted on the face panel 37 of a console 38 having a trapezoidal cross section. Face panel 37 is upwardly inclined with respect to the horizontal plane of the surface on which the base panel 39 of the console rests.

Adjacent cradle 36 on the console is the socket 40 for accommodating a hand set 41 whose cord is plugged into a console rack connected to an interface network, as in the other embodiment of adapters disclosed herein, the arrangement being generally similar to that shown in FIG. 1.

Video cell phone 35 is provided with a miniature video camera 42 and a small scale video screen 43 whose function is to display the head of the party to whom the user is speaking, this party having a similar video cell phone. It is to be noted that when it is difficult to understand what this party is saying because of noise and other interfering factors, that if one can at the same time read the moving lips of the speaker, this facilitates comprehension. It is therefore useful not only to be able to hear the speaker but also to see him clearly enough to observe his lips.

To this end it is important that the orientation of the video cell phone be such as to properly train the video camera in the cell phone toward the head of the user while bringing the video screen in line with the eyes of the user. To accomplish this result, the angle of inclination of face panel 38 lies in a 10 to 18 degree range so that a speaker seated before the desk on which the adapter is placed, can look down on the upwardly inclined video screen and clearly see the image being displayed thereon, the speaker's face then being in alignment with the video camera 42 just below video screen 43.

Because desks come in different heights and some users are taller than others, there is no one optimal angle of inclination for the console of the adapter. Hence in practice, a manually-operated mechanism may be provided to adjust the angle of the face panel, or to adjust the angle of the cradle relative to the face panel so that it is appropriate to the user of the cell phone.

And instead of providing a hand set, as shown, which plugs into the console to supplant the internal speaker and microphone of the cell phone, one may plug into the console a head set which sits on the head of the user and is provided with ear phones and a microphone.

Also one can plug into the console jack a self-sufficient speaker phone unit that includes a microphone, a loud speaker and a battery-powered amplifier. This makes possible hands-free operation of the cell phone.

When the cell phone is of the type that includes an internal electronic switching circuit adapted to activate and deactivate the transceiver in response to an external switching action, jack 20 of the cell phone then has a contact therein connected to this internal switching circuit. The interface between hand set socket switch 19 and the switching contact of jack 20 can simply be a wire extending from the socket switch to a plug that plugs into the jack to engage the switching contact. As a consequence, the adapter causes this cell phone to behave like a regular desktop telephone, for when the hand set is lifted from its socket, this action activates the transceiver so that the user can now on the keypad dial a number. And when the user returns the hand set to its socket, this action deactivates the transceiver.

In practice, an LED pilot light can be included in the interface network to be switched on when the hand set is lifted from of the socket to indicate that the phone is now active, and is switched off when the phone is returned to its socket. Should the LED not turn on when the hand set is lifted, this indicates that the battery is dead and requires recharging.

The interface network may include a tone generator for producing a dial tone, the generator being activated for a brief period when the user lifts the hand set from its socket to make a call. And the hand set instead of having a cord which must be plugged into the console may be of the wireless type. Also to improve transmission and reception by the cell phone transceiver, the adapter may be provided with a high-efficiency antenna that connects to the transceiver when the cell phone is inserted in its cradle.

Second Embodiment

As previously noted, it is known to provide a “cordless” hand set having a microwave transceiver communicating with a stationary base unit connected to a telephone line. Hence the base unit is not cordless. The advantage of a cordless hand set is that its user can operate it anywhere within the orbit of the base unit, which orbit normally is limited to a residence or office. Though mobile, a cordless hand set is not self-sufficient, for it can only function in conjunction with a wired stationary base unit.

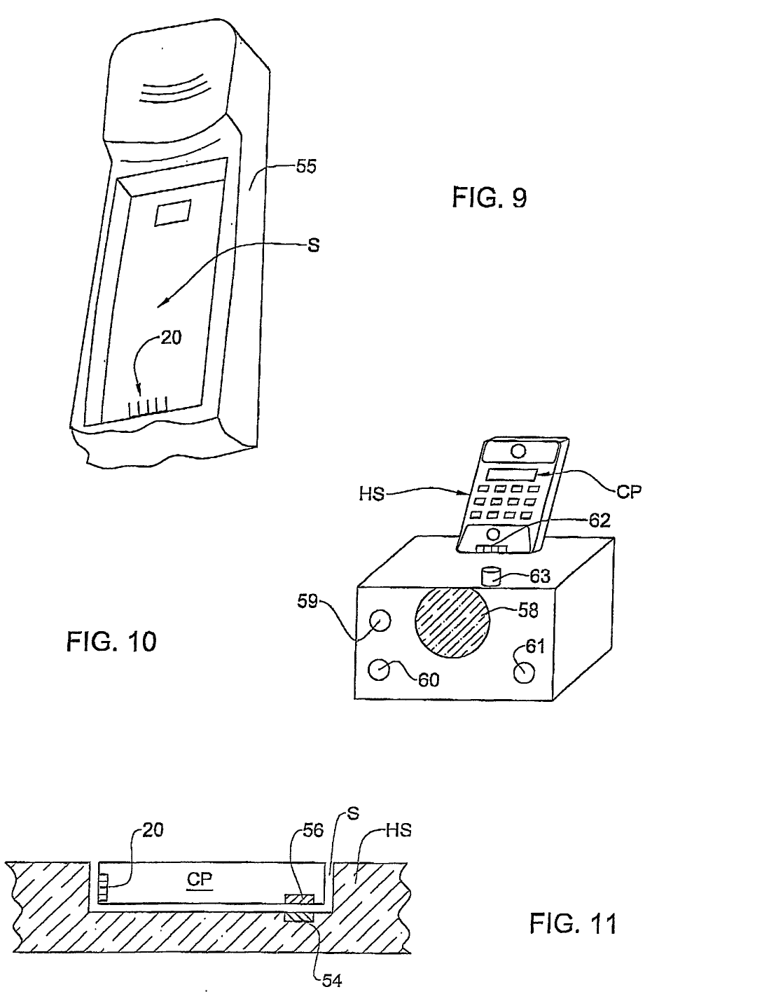

In the cell phone-hand set combination unit shown in FIGS. 8, 9 and 10, the unit is composed of a standard cell phone CP integrated with a hand set HS. The cell phone CP may be similar to that shown in FIG. 3 and therefore includes an LCD screen 13, a key pad 12 and a jack 15.

Hand set HS includes a mouthpiece 50 having a microphone 51 housed therein, and an earpiece 52 having a miniature loudspeaker 53 therein. Bridging the earpiece with the mouthpiece is a yoke 55 which serves as the handle of the hand set so that the user can raise it to his head and thereby place the earpiece against an ear and the mouthpiece adjacent his mouth. The unit is self-sufficient and cordless, and therefore is fully mobile, being useable whenever a cell phone is capable of being operated.

Cell phone CP is cradled in a rectangular recess or socket S in the yoke 55 of the hand set. The function of cradling socket S is comparable to that of cradle 17 in FIG. 3, a plug 20 mounted at the lower end of socket S plugging into the jack 15 of cell phone CP when the cell phone is socketed.

Since in this embodiment the cell phone which includes a microwave transceiver that radiated microwave energy is nested in the yoke of a handset, this reduces the exposure of the user to determine radiation. Normally, it is the cell phone that is placed against the ear of the user. But when the, cell phone is within the yoke of the handset, this lengthens the distance between the source of microwave radiation and the user's brain and significantly reduces the brain's exposure to radiation.

The interface network IN which couples hand set HS to cell phone CP and is embedded in yoke 55 is essentially the same as the interface network shown in FIG. 6. Thus when the contacts of jack 15 in the cell phone are engaged by the contacts of plug 20 in socket S, the microphone and earphone in the cell phone are then supplanted by the mouthpiece microphone 51 and the ear piece speaker 54 of the hand set.

Interface network housed in yoke 55 of the hand set is preferably formed of integrated circuit chips which may also include an amplifier for the voice signals fed to loudspeaker 54, and a volume control therefor.

In the first embodiment of the invention, the interface network is governed by a control switch which functions in two switching modes, the first taking effect when the hand set is placed in its console socket, the second when it is lifted therefrom. In the first switching mode, the cell phone is rendered inactive except to receive a ringing signal indicative of an incoming call. In the second mode, the cell phone is activated to convey an incoming call to the hand set.

In the combination unit shown in FIG. 10, cell phone CP is provided with a tiny permanent magnet button 56 formed of Alnico or ferrite material. Button 56 is so placed in the case of the cell phone that when cell phone CP is seated in socket S, magnetic button 56 is then adjacent a magnetically-actuated switch 57 in yoke 55 of the hand set, which switch activates the interface network.

A similar magnet-switching arrangement can be used to replace the mechanical switch arrangement illustrated in FIG. 6 in which control switch 19 is depressed when the handset is in place and is actuated when the handset is raised. The magnet switching arrangement which replaces the mechanical switch acts to cause switch section SW2 to engage its contact A when the handset is in place in its socket and at the same time to cause switch section SW1 to engage its contact B. But when the headset is lifted, the switch section SW2 engages its contact B and switch section SW1 engages its contact A.

Hence when cell phone CP is socketed in socket S of the hand set HS, the interface network IN is switched on to supplant the microphone and earphone of the cell phone with the microphone and speaker of the hand set. When the cell phone CP is withdrawn from the hand set, the interface network in the hand set is then switched off and the cell phone is fully operative away from the hand set.

In practice, a conventional mechanically-operated switch may be used rather than one that is magnetically actuated.

Third Embodiment

A conventional speaker phone is adapted to function in conjunction with a standard desktop telephone set so that the user of the set can switch it from a mode in which the speaker phone is inactive and the hand set must then be held in order to receive a call, or to a mode in which the hand set remains on the desktop and the speaker phone is operative. In its active mode which provides hand-free operation, the microphone and loud speaker of the speaker phone unit supplant the corresponding elements in the hand set.

In the present invention, a cell phone-hand set combination unit as in FIG. 8 is operated in conjunction with a battery-powered speaker phone SP to provide hand-free operation of the hand set. Speaker phone SP includes a loudspeaker 58, a microphone 59, a volume control 60 and a control switch 61.

In this arrangement, at the bottom end of the cell phone-hand set combination unit shown in FIG. 11 is a jack 62 into which is plugged the plug 63 of the speaker phone SP to cause the microphone and speaker of the speaker phone to supplant the corresponding elements in the combination unit.

The three embodiments of the invention disclosed herein afford the following options:

Option I

In this option, the cell phone is not combined with a hand set and can be used in a conventional manner as a mobile radio-telephone.

Option II

For this option, the cell phone is converted into a wireless desktop telephone which can be used anywhere in a home or office facility.

Option III

In this option, the cell phone is integrated with a hand set to provide a cordless combination unit that can be used wherever a mobile cell phone can be operated.

Option IV

In this option, the combination cell phone hand set unit is combined with a speaker phone to make possible hand-free operation.

Option V

All of the above can be used in conjunction with a Generation III cell phone to provide video as well as audio communication.

Modifications

A standard cell phone has two distinct sections, namely a microwave transceiver section (TS) and a keypad and LCD display section (KS), the sections being combined into a single unit. There are advantages to be gained by separating sections TS and KS into self-sufficient units provided with a coupler so that the units can be combined or disconnected.

This makes it possible to cradle the TS section unit in a handset so that it can be removed therefrom, and to incorporate the KS unit in the handset so that it combines with the TS unit only when the TS unit is cradled.

The independent TS unit can be used for purposes other than telephony. Thus it can be cradled in a video camera whose video output can then be downloaded via the unit into an Internet database. Or it can be cradled in a laptop computer to serve as a data modem.

While there bas been shown preferred embodiments of this invention, it is to be understood that many changes may be made therein without departing from the spirit of the invention.

1. A cell phone-hand set combination unit comprising:
A. a hand set provided with a mouthpiece having a microphone therein, an earpiece having a miniature loudspeaker therein, and a yoke bridging the mouthpiece and the earpiece, said yoke having a socket therein adapted to cradle a cell phone;
B. a cell phone provided with a microwave transceiver to which is coupled a microphone and an ear phone; and
C. an interface network housed in the yoke and operative when the cell phone is cradled in the socket to couple the cell phone to the hand set so that the microphone and earphone of the cell phone are supplanted by the microphone and speaker of the hand set which then functions like a cordless hand set.

2. A combination unit as set forth in claim 1 in which the cell phone includes a key pad for dialing.

3. A unit as set forth in claim 1 in which the cell phone is a Generation III phone and includes a video screen.

4. A combination unit as set forth in claim 1, further including switching means governing the operation of the network to render the network active only when the cell phone is cradled in said socket.

5. A combination unit as set forth in claim 4, in which the switching means includes a magnetically-actuated switch in the yoke underlying the socket and a magnet in the cell phone which is adjacent the switch when the cell phone is cradled.

6. A combination unit as set forth in claim 1, in which the cell phone is provided with a jack whose contacts are connected to the microphone and ear phone of the cell phone, and the hand set is provided with a plug connected to the network whereby when the plug is plugged into the jack, the microphone and earphone of the cell phone are then supplanted by the microphone and speaker of the hand set.

7. A unit as set forth in claim 1 in which an amplifier is housed in the yoke to amplify signals fed to the speaker of the hand set.

8. A unit as set forth in claim 7 in which the amplifier and the interface network are formed by IC chips.

9. A combined unit as set forth in claim 1 associated with a speaker phone unit having a microphone and loudspeaker.

10. A combined unit as set fort in claim 9 including circuit means which operate when the combined unit is coupled to the speaker phone unit to supplant the microphone and speaker of the combined unit with the microphone and speaker of the speaker phone.
